(19) United States
(12) Patent Application Publication
(10) Pub. No.: US 2009/0049492 A1
(43) Pub. Date: Feb. 19, 2009

(54) Network Architecture and Devices for Improving Performance of Hybrid Fiber Coax Cable Data Systems

(76) Inventor: Niki Pantelias, Duluth, GA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/051,458

(22) Filed: Mar. 19, 2008

Related U.S. Application Data
(60) Provisional application No. 60/935,544, filed on Aug. 17, 2007.

(51) Int. Cl. H04N 7/173

(52) U.S. Cl. 725/109

(57) ABSTRACT

Provided is a communications system including a first segment configured to (i) serve one or more end users and (ii) utilize analog signals modulated to carry digital data. The communications system also includes a second segment connectable to a headend, a protocol configured to control communication of data between the end users and the headend, and a first device configured to (i) connect the coaxial cable segment and the digital fiber-optic segment, the first device terminating the modulation and (ii) communicate over the digital fiber-optic segment to a second device. The second device is located at the headend and configured to perform other functions in accordance with the protocol.

### CROSS-REFERENCE TO RELATED APPLICATIONS

This application claims benefit to U.S. Provisional Application No. 60/935,544, filed Aug. 17, 2007, which is incorporated by reference in its entirety.

### BACKGROUND OF THE INVENTION

1. Field of the Invention

The present invention is generally related to Hybrid Fiber-Coax (HFC) cable systems for communicating digital data.

2. Related Art

Cable networks are a common means for delivering data, video, and telephony services to homes and businesses. Cable operators are constantly seeking to provide their customers with more bandwidth for less money. Operators also seek to manage their networks efficiently yet precisely to ensure that the network is used properly and for many other reasons. For instance, an operator, such as a Multiple Systems Operator (MSO), may wish to track an individual's usage for billing purposes, prevent users from consuming more network bandwidth or other resources than they are entitled to consume, or direct user requests to various channels or servers for load balancing purposes.

Today's cable networks are commonly constructed of point-to-multipoint HFC media, as shown in conventional system 100 of FIG. 1. The Data Over Cable Service Interface Specification (DOCSIS) protocol is commonly used for management of data, voice-over-IP, and newer video services. Other protocols, for example, may be used to manage older video set-top boxes. The HFC portion of these networks generally begins at a cable headend, which may be termed a hub, Master Headend, Distribution Hub, or other location, with a Cable Modem Termination System (CMTS) device. The CMTS is capable of receiving (upstream) and transmitting (downstream) analog radio-frequency (RF) signals over coaxial cable to communicate with equipment at users' homes and businesses.

Within the headend, coaxial cable is generally used to distribute RF. Upon leaving the headend, the analog RF signals are generally converted to analog optical signals which are carried over fiber-optic cables. Fiber-optic cables have less attenuation than coaxial cables, and generally offer a better Signal-to-Noise Ratio (SNR) over longer distances. Fiber is also easier and less costly to maintain, among other advantages. Many existing cable plants were originally built entirely with coaxial cable, but this is gradually being replaced with optical fiber due to the latter's advantages. Replacing coax with fiber is costly. As a result, thus far it has primarily been done for long cable runs servicing many users. Today, a fiber run will typically carry analog optical signals to between 50 and 500 users, although this number may vary widely within a cable plant or from one plant to another, and may be much higher or lower.

The point at which a fiber run terminates is called a “fiber node.” This node may be, for example, a curbside pedestal containing optical and electrical equipment. At the fiber node, the analog optical signals are converted back to RF electrical signals and delivered over coaxial cable to individual users' premises. Within their premises, users may connect a variety of DOCSIS devices to the coaxial cable, including cable modems, multimedia terminal adapters (MTAs), IP telephones, DOCSIS set-top Gateway (DSG) set-top boxes, Digital Voice Adapters (DVA), etc. Users may also connect non-DOCSIS devices such as set-top boxes using a legacy Out-of-Band control channel.

It is important to note that the coaxial cable runs from the fiber node to customer premises are a shared network. That is, all users' premises are electrically connected, and in the upstream direction, the analog signals coming from all users' premises are merged by means of analog combining circuitry to create a single signal which is sent upstream towards the CMTS. In addition, within a headend (or at other combining points in the upstream path), analog signals from different fiber nodes may be further combined in the same manner. Thus, the signal which is presented to the input of the CMTS may represent an analog combination of analog signals from many different users at many different nodes. This creates an effect called “noise funneling,” whereby the electrical noise from each user's premises is repeatedly amplified and combined with noise from other users' premises, resulting in a high noise floor at the CMTS which can degrade the SNR of all users' upstream transmissions on the plant. This in turn limits the total upstream bandwidth available to all users.

For various reasons, including reducing noise funneling and providing users more bandwidth by sharing each segment of the plant among fewer users, there is a trend among cable operators towards extending fiber runs and reducing the extent of the coaxial portions of the HFC network. An operator may “split” a node, for example by dividing a node formerly serving 200 users into two separate fiber nodes each serving 100 users. An operator may also physically run fiber “deeper” into the network, e.g. by adding or relocating fiber nodes physically closer to the end users' premises and extending existing fiber runs to reach the new node location. Thus, the coaxial portions of HFC networks are tending to get shorter and service fewer users.

The following paragraphs more fully describe the signal path between the user and the headend in conventional HFC cable plants. More specifically, the following paragraphs more fully describe the conventional system 100, shown in FIG. 1.

In the upstream direction, digital data to be transmitted from customer premises 102 becomes available at an end user's device, such as a DOCSIS cable modem 104, DOCSIS Settop Gateway (DSG) set-top box 106, legacy set-top box 108 using an Out-of-Band protocol, or other device with an interface to coaxial cable 110. The digital data is modulated to create a Radio-Frequency (RF) analog signal. Modulation may involve the use of Quadrature Amplitude Modulation (QAM), Quadrature Phase-Shift Keying (QPSK), or some other modulation method. The analog signal is carried along the coaxial cable using analog transmission, possibly involving one or more amplifiers in the signal path.

At fiber node 112, the analog signal from the coaxial cable is delivered to the input of an analog electrical-to-optical (EO) converter 114. The EO converter 114 is the interface whereby electrical signals are converted to optical form for delivery over fiber-optic cable 116, and represents one endpoint of the fiber link between the fiber node 112 and headend 118. In conventional systems, the EO converter takes an analog signal as its input and transfers that signal to an optical carrier for delivery across the fiber link. One or more amplifiers may be encountered in the fiber link before the optical signal reaches the headend.

At the headend 118, an optical-to-electrical (OE) converter 120, representing the other end of the fiber link, receives the optical signal and translates it back into an RF analog signal in electrical form.

Ideally, this analog signal would be identical to the analog signal originally applied to the input of the EO converter 114 in the fiber node 112. In practice, the analog signal received at the headend 118 will be degraded somewhat due to noise, distortion, dispersion, and other characteristics of the fiber link. However, the intention of the fiber link is to deliver the analog signal from the fiber node 112 to the headend 118 with minimal alteration and/or degradation. Such a fiber link is often referred to as an “analog fiber link,” or simply “analog fiber,” and will be described as such in this document. The input to, and output from, an analog fiber link is an analog signal.

The RF analog signal received at the headend 118 from the electrical output of the OE converter 120 may be carried over a relatively short run of coaxial cable 122 or some other medium in order to deliver the signal to a device within the headend 118, such as a CMTS 124, Out-of-Band Receiver, or similar device which can further process the signal. This device performs a demodulation operation to recover the original digital data which was transmitted by the end user's device.

In the downstream direction (not shown), the nature of the processing is very similar to the upstream processing, illustrated in FIG. 1. In the downstream direction (not shown), digital data to be transmitted becomes available at a device within the headend, such as a CMTS, EdgeQAM, Out-of-Band Transmitter, or other headend device. The digital data is modulated to create an analog signal. Modulation may involve the use of Quadrature Amplitude Modulation (QAM), Quadrature Phase-Shift Keying (QPSK), or some other modulation method. The resulting signal may be baseband, Intermediate Frequency (IF), or Radio-Frequency (RF); if it is baseband or IF, an upconverter is used to shift the carrier frequency of the analog signal to a designated frequency in the RF range. This analog RF signal is generally carried over a relatively short run of coaxial cable or some other medium, before it is delivered to the electrical input of an electrical-to-optical converter.

In the downstream direction, the electrical-to-optical converter, representing one endpoint of the fiber link between the headend and the fiber node, takes an analog signal as its input and transfers that signal to an optical carrier for delivery across the fiber link. One or more amplifiers may be encountered in the fiber link before the optical signal reaches the fiber node. At the fiber node, an optical-to-electrical converter, representing the other end of the fiber link, receives the optical signal and translates it back into an RF analog signal in electrical form. As noted above, this fiber link is considered “analog fiber” because it is intended to deliver an analog signal from one end of the fiber link to the other with minimal alteration and/or degradation, and because the input to, and output from, the fiber link is an analog signal.

The RF analog signal received at the fiber node is generally amplified within the node and is transferred to a coaxial cable segment which reaches the premises of multiple end users. The coaxial cable delivers the signal to an end user device, such as a cable modem, set-top box using an Out-of-Band protocol, or similar device capable of further processing the signal. This device performs a demodulation operation to recover the original data which was transmitted by the headend device.

Digital fiber links have become very common in modern communications system. The term “digital fiber” is sometimes used loosely within the industry. For purposes of this document, digital fiber can be differentiated from analog fiber based on the intent of the link and nature of the interface to the optical transmitter/receiver function at the physical endpoints of the fiber optic cable. The intent of a digital fiber link is to deliver information in the form of digital bits from one end of the link to the other. (Contrast this with analog fiber, where the intent is to deliver an analog signal.)

The electrical input to an optical transmitter driving a digital fiber link is in the form of digital bits. The electrical output from an optical receiver receiving a signal from a digital fiber link is also in the form of digital bits. (Contrast this with analog fiber, where the electrical input and output are each in the form of an analog signal.) Examples of digital fiber protocols in use today include Synchronous Optical Networking/Synchronous Digital Hierarchy (SONET/SDH), Gigabit Ethernet, 10 Gigabit Ethernet, Ethernet Passive Optical Networking (EPON), and Gigabit Passive Optical Networking (GPON). Some of these protocols specify only the physical (PHY) layer, while others specify both the medium-access control (MAC) and PHY layers. Other examples of digital fiber protocols may also exist.

New digital fiber protocols are under development, for example, such as 100 Gigabit Ethernet. Additional digital fiber protocols may be developed in the future. Some digital fiber protocols may take advantage of new or existing optical modulation techniques generally thought of as “analog” techniques, such as phase modulation, or other techniques. These protocols are still termed “digital fiber” for purposes of this application as long as the intent is to deliver digital information and the electrical inputs/outputs are in digital form.

Analog transmission over an HFC plant has a number of limitations. Analog HFC is limited (in both the upstream and downstream directions) by the SNR and modulation techniques available on shared coaxial cable. Coaxial cable is susceptible to noise due to external sources and due to attenuation along the cable. Thus, it can provide only limited bandwidth. Digital fiber-optic links have much better noise immunity for various reasons; for instance, the attenuation of optical fiber is lower for a given distance, and electrical noise cannot be picked up from external sources by optical cable. In a perfect world, systems operators might want to convert their systems to use digital fiber links rather than analog transmission over HFC. For example, these operators may desire to eliminate coaxial cable entirely from their network and run fiber to the home. Technologies such as Passive Optical Network (PON) exist which provide point-to-multipoint service over digital fiber to a relatively small number of users per fiber link (typically 32 or 64).

Given the trend towards splitting fiber nodes to service fewer and fewer users, some operators might wish to follow this trend to its logical conclusion and serve each user with a direct digital optical fiber link, with no coaxial cable at all outside the home, as illustrated in all-optical network 200 of FIG. 2. In the network 200, digital fiber-optic links 202 would be used to carry traffic between users and the headend. A PON network, for example, would allow a digital fiber link to be shared among typically 32 to 64 users. This all digital optical network 200 might allow more bandwidth to be delivered to each user than can be delivered with today's HFC systems, where coaxial cable runs typically pass much larger numbers of users.

Indeed, cable operators are currently experiencing competitive pressure from telephone companies such as Verizon, and from other competing network operators, who are undertaking massive network upgrades which will serve large numbers of homes directly with digital fiber optic cable. For example, Verizon is undertaking a massive deployment of PON-based systems which will ultimately reach millions of users. Cable operators need to be able to deliver similar bandwidth and services in order to remain competitive.

There are several obstacles which currently prevent cable operators from achieving a vision of digital fiber service to every home. The cost of replacing coaxial cable with fiber-optic cable is very high. The most expensive part of this upgrade is typically the “last 100 feet,” i.e. the coaxial cable run from the curbside to the home (which in practice may be less or significantly more than 100 feet). This cable run is almost always located on customer property, which is more difficult for the cable operator to access than company-owned property. Additionally, some of these cable runs may be located underground, making it necessary to locate and excavate the existing coaxial cable in order to replace it. It is very likely that the details of this cable run will be different for each one of potentially millions of customers.

Further, it is necessary to minimize and/or repair any damage to landscaping and other installations on customer property which may result from the upgrade process. These factors make the process of replacing the coaxial cable with fiber very labor-intensive, and hence very expensive and time consuming. Thus, even if an operator desires to provide a separate fiber-optic link to every user, it might still be difficult to run that fiber all the way to every user's home or office building. It might be easier for the operator to terminate the fiber run at a curbside pedestal or cabinet, an aerial pole-mounted enclosure, or some other location detached from the customer's property, and continue to use existing coaxial cable for the final run from this location to the users' buildings. Such a node could serve a single user, or multiple users might be serviced from one node.

Another challenge in converting to an all-digital-fiber network is the existence of customer premise equipment (CPE) which is designed to operate on an analog RF network. This equipment includes DOCSIS cable modems and home gateway devices, DSG set-tops, DOCSIS MTAs, and other devices utilizing protocols other than DOCSIS, as noted above. Operators have deployed and/or users have purchased tens or hundreds of millions of such devices, and deployment is likely to continue for many years. This represents billions of dollars of investment in gear which would become unusable if the operator converts to a fiber-to-the-home system which eliminated any RF communication over coaxial cable. An operator might wish to have the option of continuing to use existing CPE equipment on a network composed primarily of fiber-optic cable until the normal lifetime of that equipment has elapsed. This would preserve the value of the investment in RF-capable CPE equipment.

Another challenge relates to management of devices and traffic on the cable plant. Many of today's devices use the DOCSIS protocol both for PHY layer and MAC layer access to the plant and for management functions like quality of service, admission control, traffic policing, load balancing, statistics counting for resource management and billing purposes, etc. The DOCSIS PHY layer functions, and many of the MAC layer functions, tend to be specific to transmission on an RF network. In a PON or other optical-fiber-based system, much of the RF-specific functionality of DOCSIS would be rendered obsolete.

In light of this, it may be tempting to eliminate DOCSIS completely from a PON-based or other optical-fiber-based system. However, the management functions of DOCSIS have evolved over many years in accordance with detailed operator requirements. These functions have become very familiar to operators and are accessed by many automated backend servers which perform functions such as billing and user management. Such an elaborate, application-specific management system would be very difficult to port to a new underlying protocol, and even more difficult to replace with something entirely different. Thus, the operator may wish to retain DOCSIS functionality so that the plant may be managed in a manner similar to that which is in use today. The same considerations may apply to other established protocols as well, such as a set-top Out-of-Band control protocol.

For all these reasons and many more, what is needed, therefore, is a network architecture, and corresponding network devices, that can deliver the advantages of digital fiber without necessarily requiring that the entire physical network, installed base of CPE gear, and/or existing base of plant management systems be replaced and/or modified to use and/or work with digital fiber.

### SUMMARY OF THE INVENTION

Consistent with the principles of the present invention as embodied and broadly described herein, a communications system includes a first segment configured to (i) serve one or more end users and (ii) utilize analog signals modulated to carry digital data. The communications system also includes a second segment connectable to a headend, a protocol configured to control communication of data between the end users and the headend, and a first device configured to (i) connect the coaxial cable segment and the digital fiber-optic segment, the first device terminating the modulation and (ii) communicate over the digital fiber-optic segment to a second device. The second device is located at the headend and configured to perform other functions in accordance with the protocol.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of a conventional point-to-multipoint HFC media based communications system;

FIG. 2 is an illustration of a completely fiber based communications system which an operator might wish to deploy in place of a conventional HFC network;

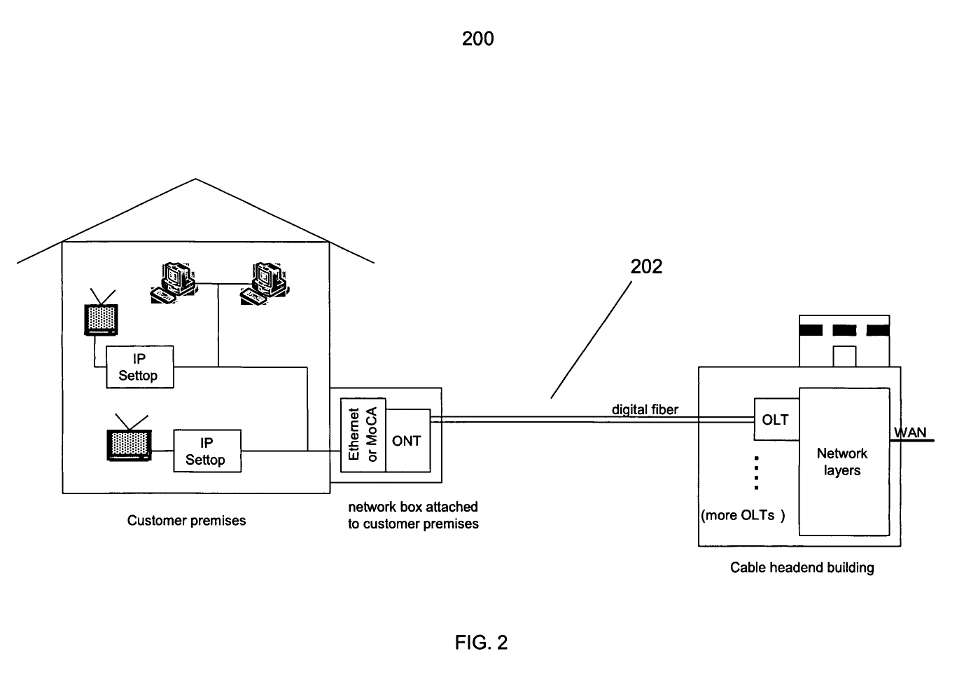

FIG. 3 is illustration of customer equipment and a device coupled together via a DOCSIS optical terminal (DOT) system in accordance with the present invention;

FIG. 4 is a more detailed view of the DOT illustrated in FIG. 3; and

FIG. 5 is a flow chart of an exemplary method of practicing an embodiment of the present invention.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

It would be apparent to one of skill in the art that the present invention, as described below, may be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

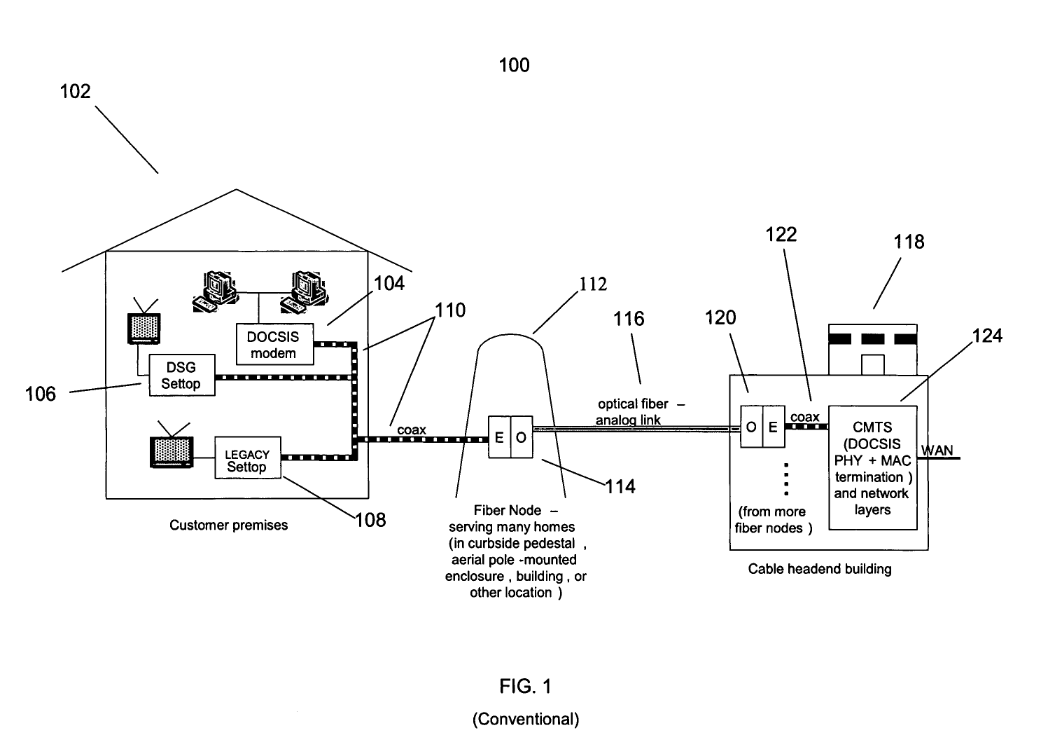

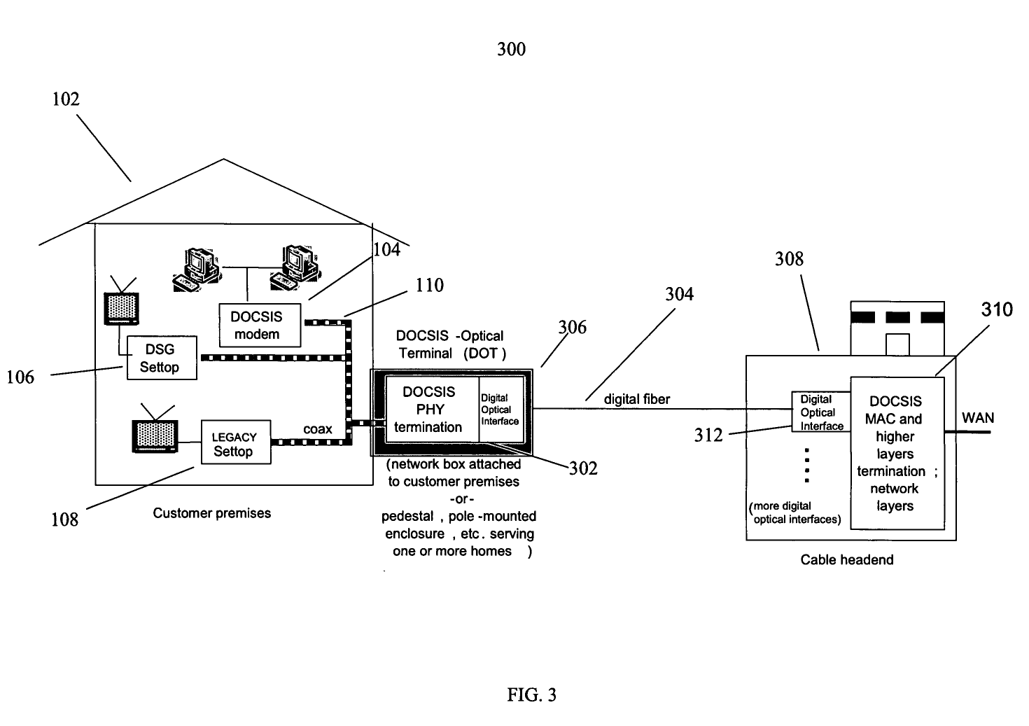

FIG. 3 illustrates an exemplary embodiment of the present invention. In FIG. 3, HFC network 300 includes a DOT 302 and digital optical fiber link 304. The HFC network 300 facilitates analog RF transmission over coax 110 (or HFC) within the customer premises 102, illustrated in FIG. 1, within users' homes or businesses, and possibly for some distance outside of these structures.

In the network 300, analog RF signals being transmitted to (downstream) and from (upstream) the customer premises 102 originate (downstream) and terminate (upstream) at the DOT 302. Although the exemplary embodiment of FIG. 3 is explained herein, within the context of DOCSIS protocols, the present invention is not limited to the DOCSIS protocols. The present invention can also apply to satellite and/or wireless communications system.

By way of example, the DOT 302 can be located either within the customer premises 102, outside the customer premises 102 in the form of a network box 306 mounted on the building, or outside the customer premises 102 in an external pedestal, cabinet, pole-mounted housing, or other equipment housing, or in a building. A single DOT can service a single customer or multiple customers, although it is desirable to keep the number of users per DOT relatively small to maximize the benefits of the system. The DOT 302 is desirably located as close to the customer premises 102 as possible.

As previously mentioned, the DOT 302 acts to terminate analog signals, such as RF transmission, to and from the customer premises 102. Thus, the DOT 302 can perform demodulation (upstream) or modulation (downstream) to convert between an analog signal on the coaxial cable 110 and the underlying digital data. Information in the form of digital bits is transmitted to (upstream) or received from (downstream) a cable headend 308 over the digital optical fiber link 304. The DOT 302 includes the logic and optical components, such as a digital optical transceiver, needed to communicate with the cable headend 308 via the digital optical fiber link 304.

At the cable headend 308, the information received/transmitted over the digital fiber link 304 is exchanged with a modified CMTS 310 which can be described, in an embodiment, as a DOCSIS MAC-layer termination device. The modified CMTS 310 is similar to a conventional CMTS. However, where a conventional CMTS terminates all DOCSIS functionality, including the analog RF functions, the modified CMTS 310 is configured to receive information digitally. The modified CMTS 310 skips the analog RF termination layer and any other functions performed in the DOT 302, and performs DOCSIS functionality beginning where the DOT 302 leaves off.

Another way to describe the HFC network 300 is to say that the functionality of a conventional CMTS, as described in the present application, is distributed between two devices: the DOT 302 and the modified CMTS 310. By way of background, the concept of distributing CMTS functionality is not new. For example, conventional DOCSIS specifications include several standards for “Modular CMTS,” which distributes downstream CMTS functionality between an M-CMTS Core (for the MAC layer and up) and an EdgeQAM (for the PHY layer).

However, prior to the present invention, the concept of distributing CMTS functionality has been postulated and/or applied primarily to achieve cost savings within a cable headend, or to distribute functionality between a larger headend location and one or more smaller headend or “hub” locations. A novel aspect of the present invention, however, is that it distributes a portion of the conventional CMTS functionality to a potentially large number of DOT devices (as many as one per user).

As illustrated in FIG. 3, the DOT 302 is ideally positioned in the vicinity of the customer premises 102. The remaining CMTS functionality (i.e., the part not contained in the DOT) remains centralized at the headend 308. In an alternative embodiment, this CMTS functionality can be distributed within a headend or between various headend buildings or locations.

The following paragraphs describe the signal path between the user and the headend in an HFC system, such as the exemplary system 300, implementing an embodiment of the present invention.

By way of review, as introduced in the discussion of FIG. 1 above, in the upstream direction, digital data to be transmitted becomes available at an end user's device, such as the cable modem 104, the DSG set-top box 106, the legacy set-top box 108 using an Out-of-Band protocol, or other device with an interface coaxial cable. The digital data is modulated to create an RF analog signal, for example, in accordance with modulation schemes listed above.

At the DOT 302, the analog signal is demodulated to recover the original digital data which was transmitted by the end user's device. The DOT 302 can optionally perform additional operations on the received data. For example, the DOT 302 can encapsulate this data, and possibly additional information such as the identity of the user device, in a form which helps the headend device 310 more effectively process the data. The DOT 302 can also perform additional operations relating to the communications protocol in use. For example, if DOCSIS is in use, the DOT 302 may perform some MAC-layer or other functions related to the DOCSIS protocol. The DOT 302 can also perform functions unrelated to the protocol in use.

Upon completion of any appropriate processing steps, the DOT 302 can deliver digital data to the electrical input of a digital optical transmitter function (not shown). The optical transmitter performs the operation of transmitting the desired digital data over the digital fiber-optic link 304 to the headend 308. At the headend 308, an optical receiver, such as that included in Digital Optical Interface 312, receives the optical signal and translates it back into the digital data sent by the DOT 302. This digital data is then delivered to a headend device capable of performing further processing on the data, such as a modified CMTS 310, Out-of-Band Receiver, or similar device.

In the system 300, modified CMTS 310 does not perform demodulation of the analog signal from the user device, since that function has already been performed by the DOT 302. In general, the modified CMTS 310 will avoid duplicating functionality which has already been performed in the DOT 302. However, the modified CMTS 310 will still perform some processing relating to the communications protocol in use.

For example, if the DOCSIS protocol is in use, the modified CMTS 310 will perform some DOCSIS functionality. Examples of such functionality may include Baseline Privacy, user authentication, traffic policing, statistics collection in accordance with DOCSIS specifications, and/or any of many other functions, though it must be observed that the invention does not require that any of the functions enumerated here actually must be present in the headend device, the exact functional partitioning being left to the discretion of the skilled practitioner.

In the downstream direction (not shown), digital data to be transmitted becomes available at a device within the headend, such as a CMTS, EdgeQAM, Out-of-Band Transmitter, or other headend device. The headend device will first complete some amount of processing on the data which relates to the protocol in use.

For example, if the DOCSIS protocol is in use, the data undergo steps such as classification to a Service Flow, assignment to a downstream channel, encapsulation in DOCSIS headers, Payload Header Suppression, and/or any of many other functions, though it must be observed that the invention does not require that any of the functions enumerated here actually must be present in the headend device, the exact functional partitioning being left to the discretion of the skilled practitioner. The headend can also perform other unrelated processing on the data. Once appropriate headend processing is complete, the data is made available for transmission. At this point, the digital data is delivered to the electrical input of a digital optical transmitter function.

The optical transmitter performs the operation of transmitting the digital data over the digital fiber-optic link to the DOT. At the DOT, an optical receiver receives the optical signal and translates it back into the digital data sent by the headend. At this point, the DOT may optionally perform some operations on the received digital data which relate to the communications protocol in use, or it may perform additional unrelated functions. In general, the DOT will avoid duplicating functionality which has already been performed by the headend device.

Upon completion of appropriate processing, the DOT performs modulation of the digital data to create an analog signal. Modulation may involve the use of QAM, QPSK, or some other modulation method. The resulting signal may be baseband, IF, or RF. If it is baseband or IF, an upconverter is used to shift the carrier frequency of the analog signal to a designated frequency in the RF range.

The RF analog signal is then delivered over a coaxial cable segment which reaches the premises of the end user. The coaxial cable delivers the signal to an end user device, such as a cable modem, set-top box using an Out-of-Band protocol, or similar device capable of further processing the signal. This device performs a demodulation operation to recover the original data which was transmitted by the DOT.

Other network architectures which on the surface may appear similar to the present invention have been postulated to allow digital fiber to replace analog HFC in a large part of the cable operators' network. However, these architectures attempt to interoperate with conventional CMTSs in the upstream direction by demodulating analog RF at or near the customer premises, carrying the resulting bits to the headend, and then remodulating the bits into analog RF which is delivered to the analog inputs of the CMTS. In essence, such a system duplicates the RF termination function of a CMTS at a location near the customer premises, and then attempts to recreate a valid analog signal at the headend.

These other architectures differ from the present invention in a number of ways. Most notably, these other architectures do not attempt to distribute the CMTS functionality, but instead attempt to duplicate part of this functionality outside of the headend, then “undo” the duplicated functionality within the headend. The key to a practical system is distribution of CMTS functionality, as described with respect to the present invention as illustrated in FIG. 3.

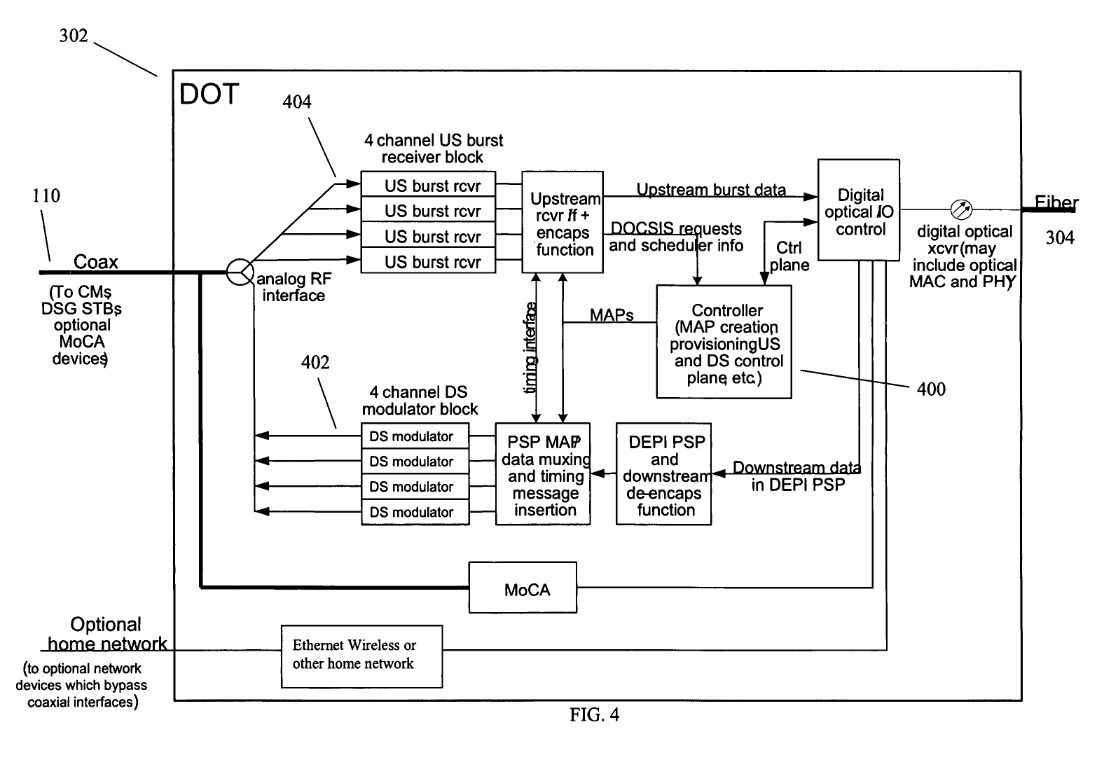

To this end, it is important to further describe the DOT 302, as illustrated in FIG. 4. In FIG. 4, the DOT 302 does not perform the function of a complete DOCSIS termination system. As understood by those of skill in the art, DOCSIS is a very complex protocol and a device which could perform all functions required by DOCSIS would be too expensive to be deployed en masse. The DOT 302 does, however, perform a minimal amount of DOCSIS processing needed to terminate the RF analog signal and deliver the resulting digital data to the headend 308. Terminating the RF analog signal means demodulating (when receiving the signal) or modulating (when transmitting the signal) to convert between the analog signal and the underlying digital data represented by that signal. In practice, the DOT 302 will likely include some amount of additional DOCSIS functionality beyond the bare minimum. The scope of said additional DOCSIS functionality need not be fixed for purposes of the present invention.

Practitioners of the present invention may choose to include different combinations and/or amounts of additional DOCSIS functionality for various reasons. These reasons include, but are not limited to: simplification of control protocol or other aspects of the design if certain functions are located in certain places; better scaling of functionality (e.g. by locating a function which must be performed once per DOT inside the DOT itself); cost reduction; and better performance resulting from reduced delays between functional blocks co-located within the DOT.

By way of example, a minimal DOT for use with the DOCSIS protocol includes the following functions:
A. an analog RF interface to coaxial cable, which may include a cable connector and various RF and/or analog functions such as upconversion;
B. an upstream DOCSIS burst receiver block, which may support one or more channels, and which receives DOCSIS burst data from DOCSIS CPE devices on the analog RF interface;
C. a MAP interface block, which can signal the DOCSIS burst receiver as to what type, length, etc. of data to receive at a given time, based on DOCSIS MAPs or related information;
D. an upstream encapsulation function, which encapsulates data received by the burst receiver and other necessary information (e.g. SID, channel ID) into a format known to the headend;
E. a downstream de-encapsulation function, which receives data and other necessary information (e.g. channel ID) from the headend and interprets it as needed to determine what data is to be sent downstream to the DOCSIS CPE devices;
F. a downstream modulator block, which may support one or more channels, and which transmits data to DOCSIS CPE devices on the analog RF interface;
G. an optical communications unit, consisting of optical MAC, PHY, and transceiver functions, a connection to optical fiber, and any other associated functionality necessary to communicate bi-directionally over digital fiber to the headend;
H. a system timing function, which ensures proper synchronization of the DOCSIS burst receiver, CPE devices, and other system components (details of this function may vary depending on what other functionality is included in the DOT). The system timing function may be local to the DOT, or may include recovery of timing information from some source outside of the DOT;
I. a controller block, responsible for provisioning and management of the other blocks, negotiation of system parameters with the headend and the CPE devices, and any other functions necessary to manage the DOT and its interactions with other devices in the system.

As mentioned above, DOCSIS standards currently exist to distribute downstream CMTS functionality between an M-CMTS Core (MAC layer) and an EdgeQAM (PHY layer). A practical downstream DOT may be designed to take advantage of this existing technology by performing many of the functions required of an EdgeQAM and implementing part or all of DOCSIS's DEPI interface, which specifies the communications protocol for controlling and sending data to/through an EdgeQAM. This “DEPI-enabled DOT” might include, among other functions, the ability to terminate DEPI PSP flows, and might use the DEPI control plane to communicate its modulator capabilities to the headend.

The use of the present invention has the effect of splitting conventional large shared analog HFC networks into a large number of much smaller analog HFC networks with much lower noise and better performance. Each of these new, smaller HFC networks has its own independent set of DOCSIS channels. For each DOCSIS upstream channel, MAP messages must be continuously created to allocate bandwidth to CPE devices which wish to transmit upstream on the HFC network. When embodiments of the present invention are used, the total number of upstream channels in the system, and hence the number of MAP messages which must be created, may become dramatically larger relative to today's system.

By way of example, in conventional systems, a single CMTS line card might support a scheduler for 12 upstream channels serving perhaps 1000 users. With the present invention, deployed so as to segment the HFC network into many segments serving small numbers of users (for instance, fewer than 10 users per DOT), serving the same 1000 users might result in 1000 upstream channels. It would be very burdensome to require the centralized headend to create MAP messages for all of these upstreams. A more scalable approach might be to include MAP creation functionality inside the DOT, so that MAPs for channels serviced by each DOT could be created by that DOT.

In the present invention, where MAP creation functionality is included in the DOT, the DOT's upstream encapsulation function can direct bandwidth requests from CPEs to the local MAP creation function. The DOT's downstream would include the ability to send locally created MAPs to CPE devices by multiplexing them into downstream data path (possibly using an existing protocol such as DEPI PSP to manage this function). The system timing function of the minimal DOT can be modified to use a locally generated timing reference, since all timing-critical functions would be contained within the DOT. This is an example of a case where an increase in cost and complexity of the DOT may be justified because it improves the scalability of the architecture by offloading an oft-repeated function from the headend.

FIG. 4 is a more detailed view of the exemplary DOT illustrated in FIG. 3. FIG. 4 is but one implementation of the exemplary DOT 302. Many other implementations of the DOT 302 are possible within the spirit and scope of the present invention. The exemplary DOT 302 illustrated in FIG. 4 shows a MAP creation function 400.

In practice, the DOT will most likely have the ability to transmit and receive on multiple DOCSIS downstream and upstream channels in order to achieve high data rates on the RF link. DOCSIS uses channel bonding protocols (standardized in DOCSIS 3.0) to combine data from multiple channels so that the user sees a single high-bandwidth connection. For instance, four standard DOCSIS downstream channels 402 might be bonded to provide a user with up to 160 Mbps of downstream bandwidth. Similarly, four standard DOCSIS upstream channels 404 might be bonded to provide up to 120 Mbps of upstream bandwidth. The bonding protocols take place at the MAC layer, and as such, are outside the scope of the minimal DOT as described in the present application.

However, practitioners of the present invention may wish to consider whether there is any value in moving some or all portions of the bonding protocol from the headend to the DOT. In terms of scalability, there may be very little gain. That is, today's CMTSs already have to support a large number of bonded “flows,” and use of the present invention does not necessarily increase the number of flows in the system. However, other factors may come into play which may increase the number of flows or otherwise raise additional considerations. Regardless, a DOT containing some or all of the DOCSIS channel bonding processing and/or management functions is within the scope of the present invention. This discussion of DOCSIS channel bonding functions is presented only by way of example, and one skilled in the art can certainly postulate other DOCSIS or non-DOCSIS functions which could be included in the DOT without departing from the spirit and scope of the present invention.

In the future, operators may wish to take advantage of evolving in-building networking technologies such as Multimedia over Coax Alliance (MOCA) which use coaxial cable to connect devices within the home or business. Operators may also someday wish to deploy CPE devices that communicate directly with the DOT over interfaces such as wireless or Ethernet, which do not involve coaxial cable, and to use these devices, in homes which also contain DOCSIS equipment. Thus, a DOT may include other interfaces, such as Ethernet, wireless, or MoCA, for communication with devices within the customer premises.

The DOT described in the present invention need not be constructed as a standalone device, located in its own cabinet, aerial node, or other location. It may be integrated with other functionality within the same cabinet, on the same printed circuit board, within the same integrated circuit, as part of the same piece of software, or any combination of these, or other appropriate form factors depending on the embodiment in use. For example, a DOT can be part of a device which delivers some services to users via the DOT, and other services to the same users via legacy analog systems or other methods.

By way of example, some of the additional benefits of the present invention are described below.

The use of digital fiber-optic links rather than analog may allow for higher data rates between the headend and the DOT, depending on the digital technology chosen. This could make more total bandwidth available on the network.

As mentioned previously, deployment of DOTs may result in a number of very small, short analog RF plants each serving a relatively small number of users. The limited extent of the coaxial cable in these plants make them much less susceptible to external noise, and also results in high signal levels since there is less signal loss over shorter runs. The resulting improvement in SNR makes it likely that the highest possible DOCSIS data rates can be achieved within each RF plant, in contrast to today's longer and more complex plants which often degrade SNR and force the use of lower data rates. The improved SNR offered by deployment of DOTs could even enable the use of modulation orders higher than those allowed by DOCSIS. For example, 1024 QAM modulation might be used in the downstream direction, and 256QAM might be used in the upstream.

The division of conventional large RF plants into a number of smaller, shorter plants drastically reduces or eliminates today's noise funneling problem. If a particular installation is subject to problems with noise or microreflections (possibly due to poor cabling practices, local sources of noise, or other issues), these problems are isolated only to that installation and do not affect other installations. Increased bandwidth is still maintained for other users. Also, the source of the problem becomes much easier to isolate and repair.

The potential increased bandwidth of digital fiber is delivered without the necessity of replacing existing deployed DOCSIS CPE equipment.

DOCSIS can be seamlessly used for management functions such as QoS, statistics gathering, authentication, etc., requiring no changes to today's operational practices in this area.

The potential increased bandwidth of digital fiber can be made available without actually running fiber (or any other new wiring) all the way to the customer's building, by deploying a DOT in a nearby pedestal or other equipment housing.

For cable operators who wish to eventually upgrade their networks (or portions thereof) to eliminate virtually all coaxial cable outside of the home in favor of digital fiber-optic links, a further advantage of the invention is that it can represent a transitional stage in the conversion of today's analog RF coaxial cable plants to digital optical fiber. By using the invention, operators whose ultimate objective is an entirely fiber-based network can deliver higher bandwidth in the near term without necessarily completing the entire upgrade all at once. Thus, they gain a return on their fiber upgrade investment sooner, and can deliver better service to their customers more quickly yet in a manner that is still consistent with their overall objective of a fully fiber-based network. It must be noted that the invention delivers many benefits even to practitioners or adopters who have no plans to transition to a fully fiber-based network.

Some other possible variations of this invention which are still within its scope are described as follows. The network in question might not be a cable network; it could be any point-to-multipoint system that uses DOCSIS, such as wireless, satellite, etc. Similarly, the digital fiber might actually not be fiber at all; it could be wireless, satellite, Amplitude-Modulated Microwave (AML), coaxial trunking, or some other technology. For example, a practitioner of this invention might wish to use a DOT to terminate DOCSIS near the customer premises and provide a digital satellite link back to a headend to gain the backwards-compatibility, seamless management, improved SNR, and other advantages of the invention.

Cable operators have a deployed base of CPE equipment which uses other protocols besides DOCSIS over the RF network—e.g. Digital Audio Video Council (DAVIC), or various protocols developed by vendors such as Motorola and Scientific-Atlanta for control of settop boxes, or other protocols entirely. This invention could be applied to those protocols in addition to or instead of DOCSIS, by terminating some or all of these protocols in the DOT and delivering the resulting bits upstream to a headend device which understands these protocols and accounts for the fact that they were partially or entirely terminated at the DOT.

In some instances, operators are concerned with increasing bandwidth only in one direction. For instance, operators may need a large increase in downstream bandwidth to enable deployment of downstream-oriented new services which require little upstream bandwidth. For example, Video-on-Demand (VOD) services often require very large amounts of downstream bandwidth, but do not use appreciable amounts of upstream bandwidth. Conversely, operators may find that they can provide adequate downstream data rates, but that a large improvement is needed on upstream channels which are suffering from noise funneling. For these and/or other reasons, operators may wish to gain the advantages of this invention in one direction only, while continuing to use their existing plant architecture in the other direction.

For these purposes, DOTs could be developed which implement the invention in one direction only and omit the functions of the other direction. An upstream-only DOT might contain all of the upstream-related blocks of a minimal DOT, but omit some or all of the downstream-specific blocks. Similarly, a downstream-only DOT might contain all of the downstream-related blocks of a minimal DOT, but omit some or all of the upstream-specific blocks. These DOTs actually could be smaller in scope than what has thus far been described as a “minimal DOT”, indicating that the term “minimal” should not be taken too literally. Naturally, either of these DOTs could include additional functionality beyond that described as “minimal” in the direction of interest.

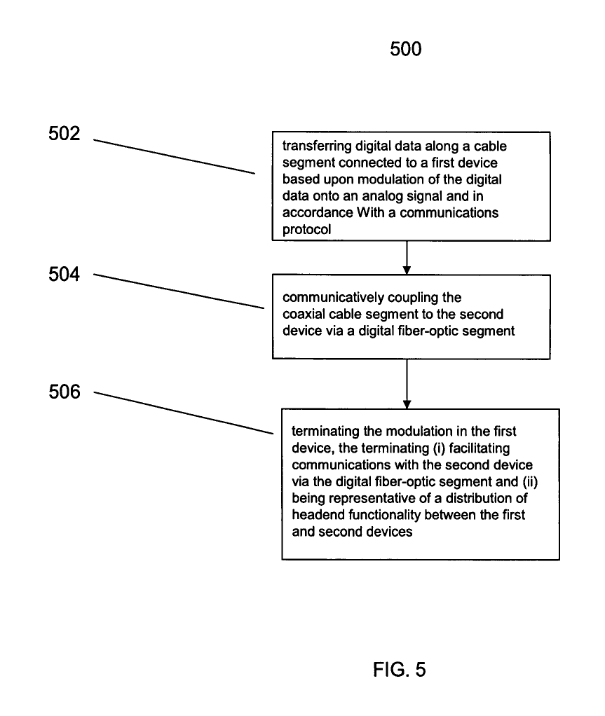

FIG. 5 is a flow chart of an exemplary method 500 of practicing an embodiment of the present invention. In the method 500, digital data is transferred along a cable segment connected to a first device based upon modulation of the digital data onto an analog signal and in accordance with a communications protocol in step 502. In step 504, the coaxial cable segment is communicatively coupled to the second device via a digital fiber-optic segment. In step 506, the analog signal is terminated in the first device, the terminating (i) facilitating communications with the second device via the digital fiber-optic segment and (ii) being representative of a distribution of headend device functionality between the first and second devices.

### CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A communications system, comprising:
a first segment configured to (i) serve one or more end users and (ii) utilize analog signals modulated to carry digital data;
a second segment connectable to a headend;
a protocol configured to control communication of data between the end users and the headend;
a first device configured to (i) connect the coaxial cable segment and the digital fiber-optic segment, the first device terminating the modulation and (ii) communicate over the digital fiber-optic segment to a second device;
wherein the second device is located at the headend and configured to perform other functions in accordance with the protocol.

2. The communications system of claim 1, wherein the first and second segments include coax and fiber, respectively.

3. The communications system of claim 2, wherein the other functions exclude the terminating the modulation.

4. The communications system of claim 3, wherein the protocol includes Data Over Cable Service Interface Specification (DOCSIS) protocols.

5. The communications system of claim 1, wherein the protocol includes Data Over Cable Service Interface Specification (DOCSIS) protocols;
wherein the first device is a DOCSIS Optical Terminal (DOT); and
wherein functionality within the DOT excludes complete DOCSIS termination system functionality as complete DOCSIS termination functionality is defined within the DOCSIS protocols.

6. The communications system of claim 1, wherein the other functions are representative of a first portion of a cable modem termination system (CMTS) functionality in accordance with Data Over Cable Service Interface Specification (DOCSIS) protocols; and
wherein termination of the modulation is representative of a second portion of the CMTS functionality, the first and second portions of the CMTS functionality being distributed between the first device and the second device.

7. The communications system of claim 6, wherein the first and second device are a DOCSIS Optical Terminal (DOT) and a modified CMTS, respectively; and
wherein the modified CMTS is configured to receive digitally transmitted data.

8. A method for communicating digital data between a first device and a second device, comprising:
transferring digital data along a coaxial cable segment connected to the first device based upon (i) modulation of the digital data onto an analog signal and (ii) a communications protocol;
communicatively coupling the coaxial cable segment to the second device via a digital fiber-optic segment; and
terminating the modulation principles in the first device, the terminating (i) facilitating communications with the second device via the digital fiber-optic segment and (ii) being representative of a distribution of headend functionality between the first and second devices.

9. The method of claim 8, wherein the communications protocol includes Data Over Cable Service Interface Specification (DOCSIS) protocols.

10. A device configured to convert between an input analog signal and an underlying information signal embedded therein, comprising:
a first direction receiver;
a first encapsulation device configured to encapsulate data output from the first direction receiver; and
an optical communications unit configured to perform at least one from the group including (i) optically communicating the encapsulated data output from the first encapsulation device and (ii) optically communicating data received from a second direction optical communications link.

11. The device of claim 10, further comprising a second encapsulation device configured to encapsulate data received via the optical communications link after the optical communications unit communicates the data received from the second direction optical communications link; and
a modulation block configured to modulate the encapsulated data output from the second encapsulation device.

12. The device of claim 11, further comprising an analog interface configured to output the modulated encapsulated data to a radio frequency (RF) communications link.

13. The device of claim 12, wherein the first direction receiver is an upstream burst receiver; and
wherein the second direction optical communications link is a downstream optical communications link.
